(19) United States
(12) Patent Application Publication
(10) Pub. No.: US 2013/0204027 A1
(43) Pub. Date: Aug. 8, 2013

(54) PRODUCTION OF SILAOXACYCLES

(71) Applicant: Elke Fritz-Langhals, Ottobrunn (DE)

(72) Inventor: Elke Fritz-Langhals, Ottobrunn (DE)

(73) Assignee: WACKER CHEMIE AG, Munich (DE)

(21) Appl. No.: 13/636,078

(22) PCT Filed: Mar. 8, 2011
(86) PCT No.: PCT/EP11/53490

§ 371 Date: Nov. 8, 2012

(30) Foreign Application Priority Data
Mar. 22, 2010 (DE) 10 2010 003 110.0

(51) Int. Cl. C07F 7/18

(52) U.S. Cl. CPC C07F 7/188
USPC 556/443

(57) ABSTRACT

Siloxacycles are efficiently prepared from compounds of the formula

R¹—C(═O)—[O—CH₂—Si(R²)₂]ₙ—OR³ (II)

by reaction in the presence of an alcohol and an acidic catalyst selected from organic resins with sulfo groups, acidic alumina, clay minerals, montmorillonites, acidic zeolites, iso- and heteropolyacids. The products can be produced in high yield and purity and are suitable for effectively end capping organopolysiloxanes.

### CROSS-REFERENCE TO RELATED APPLICATIONS

This application is the U.S. national phase of PCT Application No. PCT/EP2011/053490 filed Mar. 8, 2011 which claims priority to German application 10 2010 003 110.0 filed Mar. 22, 2010, the disclosures of which are incorporated in their entirety by reference herein.

### BACKGROUND OF THE INVENTION

1. Field of the Invention

The present invention relates to a process for preparing silaoxacycles having structural units in which silicon and oxygen atoms are bonded to one another via a CH₂ group.

2. Description of the Related Art

Silaoxacycles in which silicon and oxygen atoms are bonded to one another via a CH₂ group are excellent reagents for the preparation of (hydroxymethyl)-polysiloxanes by termination of silicone oils according to the following reaction equation:

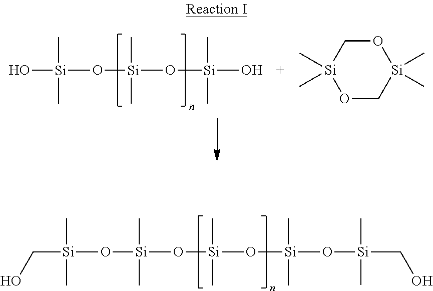

Since the silaoxacycle used as the terminating reagent, being a cyclic compound, has no end groups or the like which have to be eliminated in the reaction, the reaction I is a smooth addition reaction without any condensation products which would have to be removed thereafter. The thus produced carbinol oil terminated with Si—CH₂—OH groups is of excellent suitability for the preparation of “AA-BB” polymers, for example by reaction with diisocyanates, provided that the termination is quantitative, since every Si—OH group which is not terminated with an Si—CH₂—OH group is converted in the course of subsequent preparation of AA-BB polymers by means of diisocyanates to an Si—O—C(O)—NH— group, the Si—O bond of which constitutes a hydrolysis-sensitive cleavage site. The greater the purity of the silaoxacycle used, the smoother the termination.

The specialist literature describes various methods for preparation of silaoxacycles in which silicon and oxygen atoms are bonded to one another via a CH₂ group.

For instance, the preparation of 2,2,5,5-tetramethyl-1,4-dioxa-2,5-disilacyclohexane by heating of 1,3-bis-(hydroxymethyl)-1,1,3,3-tetramethyldisiloxane over calcium oxide as a desiccant has been described in U.S. Pat. No. 2,898,346 and Journal of Organic Chemistry 1960, vol. 25, p. 1637-1640. However, this process gives the product only in a 40-60% yield and requires the use of calcium oxide in a molar amount, in order that the water formed can be fully bound. The process gives an impure product, recognizable by the broad boiling range of the product fraction and by the elemental analysis reported, which has distinct deviations from the theoretical values. The poor purity of the product thus prepared is confirmed by Chemische Berichte 1966, vol. 99, p. 1368-1383 (see footnote 10 therein on p. 1373).

Chemische Berichte 1966, vol. 99, p. 1368-1383 describes a process for preparing 2,2,5,5-tetramethyl-1,4-dioxa-2,5-disilacyclohexane (1) by heating (acetoxymethyl)ethoxydimethylsilane with a large excess of 13 molar equivalents of methanol in the presence of p-toluenesulfonic acid (p-TsOH) to give ethoxy(hydroxymethyl)dimethylsilane, neutralizing the resulting primary product and then, after again adding p-toluenesulfonic acid, distilling gradually with elimination of ethanol (reaction III):

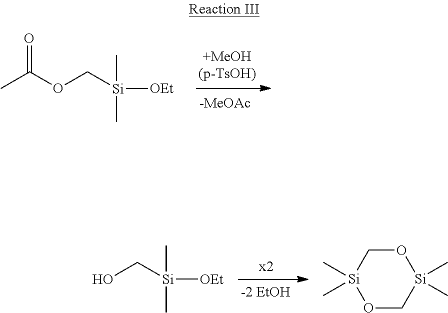

This process, however, is uneconomical since it enables only poor space-time yields, because more than ⅔ of the reaction volume consists of methanol. After distillative removal of methyl acetate, a neutralization step is conducted with potassium hydroxide and CO₂, and then the actual product, 2,2,5,5-tetramethyl-1,4-dioxa-2,5-disilacyclohexane (1), after again adding p-toluenesulfonic acid, is obtained by distillation. These individual steps additionally make the process laborious. In the case of distillation in the presence of free p-toluenesulfonic acid, there is the risk of formation of linear or cyclic ether moieties Si—CH₂—O—CH₂—Si which, as likewise described in Chem. Ber. 1966, vol. 99, page 1371, form readily with elimination of water under the influence of the p-toluenesulfonic acid. This mode of operation means that the distillation step has only poor reproducibility. The presence of such ether moieties limits the use of the silaoxacycles as end-capping reagents for polysiloxanes, since they recur unchanged in the product.

The reference Organosilicon Chemistry, Scientific Communications, Prague, 1965, p. 120-124 shows basically the same reaction route in the form of reaction equations, but does not contain any working or procedural instructions which would enable skilled persons to comprehend the reaction sequence shown therein or to isolate a product.

2,2,5,5-Tetramethyl-1,4-dioxa-2,5-disilacyclohexane (1), 2,5-dimethyl-2,5-diphenyl-1,4-dioxa-2,5-disilacyclohexane and 2,2,5,5-tetraphenyl-1,4-dioxa-2,5-disilacyclohexane were prepared by condensation of (hydroxymethyl)dimethylsilane, (hydroxymethyl)methyl-phenylsilane and (hydroxymethyl)diphenylsilane respectively, with elimination of hydrogen (Zeitschrift fur Naturforschung B, 1983, vol. 38, p. 190-193). The reacting groups are in the same molecule, as a result of which safe storage of the reactant in industry is impossible.

Moreover, the specialist literature describes various methods for transesterification of silanes bearing an acyloxyalkyl group.

DE 1 251 961 B describes the preparation of cyclic silane compounds whose structure can be represented by the formula *-O—R′—SiR″₂-* where * is the point of ring closure and R′ is a divalent hydrocarbyl radical which connects the silicon and oxygen atoms via at least three carbon atoms. This involves subjecting an ester of the structure acyl-O—R′—SiR″₂—OR′″ to a transesterification reaction with an alcohol. If the thus prepared compounds of the structure *-O—R′—SiR″₂-* are reacted analogously to reaction I with silicone oils, the products formed, however, have a comparatively high organic component since R′ has at least three carbon atoms, which is disadvantageous with regard to properties such as flame retardancy of the successor products.

Union Carbide has described, in several applications (see EP 129 121 A1, EP 120 115 A1, EP 107 211 A2, EP 106 062 A2, EP 93 806 A1, EP 73 027 A2 and EP 49 155 A2), the preparation of acyclic products having repeat units of the structure *[O—R′—SiR″₂—]ₚ* (*=end groups or undefined groups). This involves subjecting an ester of the structure acyl-O—R′—SiR″₂—OR′″ to a trans-esterification reaction with elimination of an ester acyl-OR′″, which is distilled out of the reaction mixture, the chain length distribution p of the product being controlled by the extent to which the trans-esterification is driven, and it is possible to add, as regulators to limit the extent of transesterification, high-boiling esters such as ethyl benzoate, methyl benzoate or ethyl laurate, which bring about blocking of the * end groups of the product by incorporating the acyl radical and the alkoxy radical of the high-boiling ester added into the product as * end groups. However, the preparation of cyclic compounds which could be isolated or purified, for example, by distillation has not been described.

The preparation of homocondensates of (hydroxymethyl)-silanes is also described in DE 44 07 437 A1. However, the document describes only how transesterification of (acyloxymethyl)silanes with alcohols gives an inhomo-geneous mixture of linear or branched condensates.

### SUMMARY OF THE INVENTION

The invention provides a process for preparing silaoxacycles of the general formula I

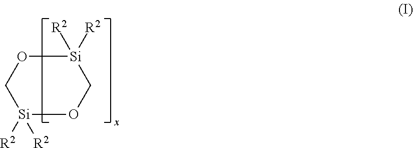

in which compounds of the general formula II

R¹—C(═O)—[O—CH₂—Si(R²)₂]ₙOR³ (II)

are converted in the presence of acidic catalyst and alcohol A, using 0.01 to 7 molar equivalents of alcoholic OH groups of the alcohol A per 1 molar equivalent of [O—CH₂—Si(R²)₂] units of the compounds of the general formula II and isolating the silaoxacycles of the general formula I after removing the acidic catalyst, where
x represents integers greater than or equal to 0,
n represents integers greater than or equal to 1,
R¹ is a hydrocarbyl radical which is unsubstituted or substituted by one or more Q¹ groups and may be interrupted by one or more heteroatoms, or an OR³ group,
R² is a hydrocarbyl radical which is unsubstituted or substituted by one or more Q¹ groups and may be interrupted by one or more heteroatoms, or an OR⁴ group,
R³ is a hydrocarbyl radical which is unsubstituted or substituted by one or more Q¹ groups and may be interrupted by one or more heteroatoms,
R⁴ is a hydrocarbyl radical which is unsubstituted or substituted by one or more Q¹ groups and may be interrupted by one or more heteroatoms, and
Q¹ is a monovalent, divalent or trivalent heteroatom-containing radical,
   where R¹, R², R³, R⁴ and Q¹ may be joined to one another so as to form one or more rings.

### DETAILED DESCRIPTION OF THE PREFERRED EMBODIMENTS

The process is efficient and economic. By virtue of the process, the silaoxacycles of the general formula I can be made available in a purity which allows direct further use, for example according to the above reaction I.

It has been found that, surprisingly, the desired silaoxacycles can be prepared easily in a robust process and in high purity when silanes having acyloxymethyl and alkoxy groups are subjected to a transesterification in a particular manner.

The compounds of the general formula II, the alcohol A and the acidic catalyst can each be used in a mixture or as a pure substance. The silaoxacycles of the general formula I can likewise be obtained as a mixture or as a pure substance. Identical or different compounds of the general formula II, identical or different catalysts and identical or different alcohols A can be added successively in a plurality of steps.

Preferably, at least one compound of the general formula I is isolated from the reaction mixture. The isolation of the compound of the general formula I from the reaction mixture is preferably accomplished by distillation, in which case the compound of the general formula I is distilled over as distillate.

In the process, a by-product of the general formula III

R¹—C(═O)—OR³ (III)

is generally likewise removed, for example by distillation, in which case the by-product of the general formula III, according to the choice of R¹ and R³ radicals, can be obtained as distillate or as distillation residue.

x preferably assumes values from 1 to 30, more preferably values from 1 to 3, and most preferably the value of 1. x may assume, for example, the values of 1, 2, 3, 4, 5, 6, 7, 8, 9 or 10.

n preferably assumes values from 1 to 30, more preferably values from 1 to 3, and most preferably the value of 1. n may assume, for example, the values of 1, 2, 3, 4, 5, 6, 7, 8, 9 or 10.

R¹ is, for example, a hydrogen atom or a linear or branched, saturated or mono- or polyunsaturated hydro-carbyl radical which is cyclic or acyclic or contains a plurality of cycles or - when R¹ is an OR³ group - a hydrocarbyloxy radical. R¹ is preferably a hydrogen atom or a C₁-C₄₀ alkyl radical, a C₆-C₄₀ aryl radical, a C₇-C₄₀ alkylaryl radical or a C₇-C₄₀ arylalkyl radical. R¹ is more preferably a hydrogen atom, a C₁-C₂₀ alkyl radical, a C₆-C₂₀ aryl radical, a C₇-C₂₀ alkylaryl radical or a C₇-C₂₀ arylalkyl radical. R¹ is most preferably a hydrogen atom, a C₁-C₁₂ alkyl radical, a C₆-C₁₂ aryl radical, a C₇-C₁₂ alkylaryl radical or a C₇-C₁₂ arylalkyl radical. R¹ preferably contains zero to four heteroatoms, especially zero heteroatoms. R¹ is preferably unsubstituted. R¹ most preferably consists exclusively of carbon and hydrogen atoms or is a hydrogen atom. Examples of R¹ are hydrogen, methyl, ethyl, n-propyl, isopropyl, n-butyl, isobutyl, sec-butyl, tert-butyl, n-pentyl, tert-pentyl, n-hexyl, n-heptyl, 1-ethylpentyl, n-octyl, n-nonyl, n-decyl, n-undecyl, n-tridecyl, n-pentadecyl, n-heptadecyl, n-nonadecyl, phenyl, benzyl, 2-methylphenyl, 3-methylphenyl, and 4-methylphenyl.

R² is, for example, a linear or branched, saturated or mono- or polyunsaturated hydrocarbyl radical which is cyclic or acyclic or contains a plurality of cycles, or when R² is an OR⁴ group, contains a hydrocarbyloxy radical. R² is preferably a C₁-C₄₀ alkyl radical, a C₆-C₄₀ aryl radical, a C₇-C₄₀ alkylaryl radical, a C₇-C₄₀ arylalkyl radical, a C₁-C₄₀ alkoxy radical, a C₂-C₄₀ (alkoxy)alkoxy radical, a C₆-C₄₀ aryloxy radical, a C₇-C₄₀ arylalkoxy radical or a C₇-C₄₀ alkylaryloxy radical. R² is more preferably a C₁-C₂₀ alkyl radical, a C₆-C₂₀ aryl radical, a C₇-C₂₀ alkylaryl radical or a C₇-C₂₀ arylalkyl radical, a C₁-C₂₀ alkoxy radical, a C₂-C₂₀ (alkoxy)alkoxy radical, a C₆-C₂₀ aryloxy radical, a C₇-C₂₀ arylalkoxy radical or a C₇-C₂₀ alkylaryloxy radical. R² is most preferably a C₁-C₁₂ alkyl radical, a C₆-C₁₂ aryl radical, a C₇-C₁₂ alkylaryl radical or a C₇-C₁₂ arylalkyl radical, a C₁-C₁₂ alkoxy radical, a C₂-C₁₂ (alkoxy)alkoxy radical, a C₆-C₁₂ aryloxy radical, a C₇-C₁₂ arylalkoxy radical or a C₇-C₁₂ alkylaryloxy radical. R² preferably contains zero to four heteroatoms, more preferably zero or one heteroatom, and most preferably no heteroatom when R² is not OR⁴, and more preferably one to two oxygen atoms, especially one oxygen atom, when R² is OR⁴. R² is preferably unsubstituted or substituted by one alkoxy group, especially unsubstituted. Most preferably, R² consists exclusively of carbon and hydrogen atoms or of carbon and hydrogen atoms and one oxygen atom; in the latter case, this oxygen atom is preferably bonded to the silicon atom. Examples of R² are methyl, ethyl, vinyl, allyl, ethynyl, propargyl, 1-propenyl, 1-methylvinyl, methallyl, phenyl, benzyl, ortho-, meta- or para-tolyl, methoxy, ethoxy, 2-methoxyethoxy, 2-methoxy-1-methylethoxy, n-propoxy, isopropoxy, n-butoxy, isobutoxy, sec-butoxy, tert-butoxy, tert-pentoxy, n-hexoxy, 2-ethylhexoxy, n-octoxy, n-decoxy, n-dodecoxy, n-tetradecoxy, n-octadecoxy, n-eicosoxy, phenoxy or benzyloxy.

R³ is, for example, a linear or branched, saturated or mono- or polyunsaturated hydrocarbyl radical which is cyclic or acyclic or contains a plurality of cycles. R³ is preferably a C₁-C₄₀ alkyl radical, a C₆-C₄₀ aryl radical, a C₇-C₄₀ alkylaryl radical, a C₇-C₄₀ arylalkyl radical or a C₂-C₄₀ (alkoxy)alkyl radical. R³ is more preferably a C₁-C₂₀ alkyl radical, a C₆-C₂₀ aryl radical, a C₇-C₂₀ alkylaryl radical, a C₇-C₂₀ arylalkyl radical or a C₂-C₂₀ (alkoxy)alkyl radical. R³ is most preferably a C₁-C₁₂ alkyl radical, a C₆-C₁₂ aryl radical, a C₇-C₁₂ alkylaryl radical, a C₇-C₁₂ arylalkyl radical or a C₂-C₁₂ (alkoxy)alkyl radical. R³ preferably contains zero to four heteroatoms, more preferably zero or one heteroatom, and most preferably no heteroatom. R³ is preferably unsubstituted or substituted by one alkoxy group, especially unsubstituted. R³ most preferably consists exclusively of carbon and hydrogen atoms or of carbon and hydrogen atoms and one oxygen atom, this oxygen atom being part of an ether group, i.e. bonded to two carbon atoms. Examples of R³ are methyl, ethyl, 2-methoxyethyl, 1-methyl-2-methoxyethyl, n-propyl, isopropyl, n-butyl, isobutyl, sec-butyl, tert-butyl, n-pentyl, tert-pentyl, n-hexyl, 2-ethylhexyl, n-octyl, n-decyl, n-dodecyl, n-tetradecyl, n-hexadecyl, n-octadecyl, n-eicosyl, phenyl or benzyl.

R⁴ is, for example, a linear or branched, saturated or mono- or polyunsaturated hydrocarbyl radical which is cyclic or acyclic or contains a plurality of cycles. R⁴ is preferably a C₁-C₄₀ alkyl radical, a C₆-C₄₀ aryl radical, a C₇-C₄₀ alkylaryl radical, a C₇-C₄₀ arylalkyl radical or a C₂-C₄₀ (alkoxy)alkyl radical. R⁴ is more preferably a C₁-C₂₀ alkyl radical, a C₆-C₂₀ aryl radical, a C₇-C₂₀ alkylaryl radical, a C₇-C₂₀ arylalkyl radical or a C₂-C₂₀ (alkoxy)alkyl radical. R⁴ is most preferably a C₁-C₁₂ alkyl radical, a C₆-C₁₂ aryl radical, a C₇-C₁₂ alkylaryl radical, a C₇-C₁₂ arylalkyl radical or a C₂-C₁₂ (alkoxy)alkyl radical. R⁴ preferably contains zero to four heteroatoms, more preferably zero or one heteroatom, and most preferably no heteroatom. R⁴ is preferably unsubstituted or substituted by one alkoxy group, especially unsubstituted. R⁴ most preferably consists exclusively of carbon and hydrogen atoms or of carbon and hydrogen atoms and one oxygen atom, in which case this oxygen atom is part of an ether group, i.e. is bonded to two carbon atoms. Examples of R⁴ are methyl, ethyl, 2-methoxyethyl, 1-methyl-2-methoxyethyl, n-propyl, isopropyl, n-butyl, isobutyl, sec-butyl, tert-butyl, n-pentyl, tert-pentyl, n-hexyl, 2-ethylhexyl, n-octyl, n-decyl, n-dodecyl, n-tetradecyl, n-hexadecyl, n-octadecyl, n-eicosyl, phenyl or benzyl.

Q¹ is preferably a halogen atom, for example a fluorine, chlorine, bromine or iodine atom, a hydrocarbyloxy group, for example a C₁-C₄₀ alkoxy group or a C₆-C₄₀ aryloxy group, an acyl group, for example an aliphatic C₁-C₄₀ acyl group, or an aromatic C₇-C₄₀ acyl group, a hydrocarbyl sulfide group, for example a C₁-C₄₀ alkyl sulfide group or a C₆-C₄₀ aryl sulfide group, a cyano group or a nitro group.

In a particularly preferred combination, the above-defined groups are selected such that the R¹ radical is a hydrogen atom, a methyl group or an ethyl group, the R² radicals are each independently methyl, methoxy or ethoxy groups, especially methyl groups, the R³ radical is a methyl or ethyl group, n assumes integer values from 1 to 3, especially 1, and x assumes integer values from 1 to 3, especially 1.

The structural unit [O—CH₂—Si(R²)₂]ₙ in the general formula II may be linear or branched. If, for example, the compounds of the general formula II selected were compounds where R¹=Me, R²=OMe and OR³=OMe, the general formula II may represent structures including the following:

Me-C(═O)—[O—CH₂—Si(OMe)₂]—OMe n=1

Me-C(═O)—[O—CH₂—Si(OMe)₂-O—CH₂—Si(OMe)₂]—OMe n=2 (linear)

Me-C(═O)—[O—CH₂—Si(OMe)₂-O—CH₂—Si(OMe)₂-O—CH₂—Si(OMe)₂]—OMe n=3 (linear)

Me-C(═O)—[O—CH₂—Si(O—CH₂—Si(OMe)₃)₂]—OMe n=3 (branched)

Me-C(═O)—[O—CH₂—Si(O—CH₂—Si(OMe)₃)₂—O—CH₂—Si(OMe)₂]—OMe, n=4 (branched, selected example)

where the structural units in square brackets always have the empirical formula of [O—CH₂—Si(OMe)₂]ₙ with the particular specified value of n.

Compounds of the general formula II are, for example, when n=1, preparable by a process as described in Monatshefte fur Chemie 2003, vol. 134, p. 1081-1092 (see the section “General Procedure for the Synthesis of 1-4” in the reference at p. 1090); instead of the methacrylic acid described therein, it is also possible to use another carboxylic acid of the general formula R¹COOH.

The process is executed in the presence of at least one acidic catalyst.

Acidic catalysts usable in the process are Brønsted acids (proton donors) preferably with pKₐ values of −12 to +9. Suitable Brønsted acids are, for example, hydrohalic acids, e.g. HF, HCl, HBr and HI.

Suitable acidic catalysts are oxygen acids of the elements of main groups 3 to 7, the acidic salts thereof and acidic esters thereof, where one or more oxygens may be substituted by halogen, especially fluorine, for example boric acid, carbonic acid, nitrous acid, nitric acid, phosphorous acid, lithium dihydrogenphosphite, sodium dihydrogenphosphite, potassium dihydrogenphosphite, rubidium dihydrogenphosphite and cesium dihydrogenphosphite, mono- or diesters of phosphorous acid [(R⁵O)_{q}P(OH)_{3-q}) where q=1 or 2], phosphoric acid, lithium dihydrogenphosphate, sodium dihydrogenphosphate, potassium dihydrogenphosphate, rubidium dihydrogenphosphate and cesium dihydrogenphosphate, mono- or diesters of phosphoric acid [(R⁶O)_{q}P(O)(OH)_{3-q}) where q=1 or 2], sulfurous acid, lithium hydrogensulfite, sodium hydrogensulfite, potassium hydrogensulfite, rubidium hydrogensulfite and cesium hydrogensulfite, sulfuric acid, lithium hydrogensulfate, sodium hydrogensulfate, potassium hydrogensulfate, rubidium hydrogensulfate and cesium hydrogensulfate, monoesters of sulfuric acid (R⁷OSO₃H), chloric acid and perchloric acid, bromic acid and perbromic acid, iodic acid and periodic acid, tetrafluoroboric acid, hexafluorophosphoric acid.

Suitable acidic catalysts are also carboxylic acids (R⁸—COOH). Suitable acidic catalysts are also oxygen acids of the elements P and S which bear a carbonaceous radical covalently bonded to P or S, for example sulfonic acids (R⁹—SO₃H) and phosphonic acids [R¹⁰—P(O)(OH)₂].

Suitable acidic catalysts are also carboxyl-containing organic polymers which may be linear, branched or crosslinked. The polymers contain preferably 0.1 mol to 10 mol and more preferably 1 mol to 5 mol of carboxyl groups per kg of polymer.

Suitable acidic catalysts are also sulfo-containing organic polymers which may be linear, branched or crosslinked. The polymers preferably contain 0.1 mol to mol and more preferably 1 mol to 5 mol of sulfo groups per kg of polymer.

The carboxyl-containing and sulfo-containing organic polymers are preferably crosslinked, which means that they are in the form of resins. The polymeric base skeleton of the resins consists, for example, of polycondensates of phenol and formaldehyde, of copolymers of styrene and divinylbenzene or of copolymers of methacrylates and divinylbenzene.

Suitable acidic catalysts are also amidosulfonic acids (R¹¹R¹²NSO₃H).

Suitable acidic catalysts are also acidic alumina, clay minerals, montmorillonites, attapulgites, bentonites, acidic zeolites, iso- and heteropolyacids.

Acidic zeolites are described, for example, in Ullmann's Encyclopedia of Industrial Chemistry vol. 39, p. 646 (Wiley-VCH 2003).

Isopolyacids are condensates of inorganic polybasic acids with a central atom type selected from Si, P, V, Mo and W, for example polymeric silica, molybdic acid and tungstic acid. Heteropolyacids are inorganic polyacids with at least two different central atoms from in each case polybasic oxygen acids of a metal, especially Cr, Mo, V, W, and of a nonmetal, especially As, I, P, Se, Si, Te, for example 12-molybdato-phosphoric acid (H₃[PMo₁₂O₄₀]) or 12-tungstophosphoric acid (H₃[PW₁₂O₄₀]).

R⁵, R⁶, R⁷, R⁸, R⁹ and R¹⁰ are each independently hydrocarbyl radicals which are unsubstituted or substituted by one or more Q² groups and may be interrupted by one or more heteroatoms, where Q² is a monovalent, divalent or trivalent heteroatom-containing radical.

R¹¹ and R¹² are each independently hydrogen or hydrocarbyl radicals which are unsubstituted or substituted by one or more Q³ groups and which may be interrupted by one or more heteroatoms, where Q³ is a monovalent, divalent or trivalent heteroatom-containing radical.

R⁵ is, for example, a linear or branched, saturated or mono- or polyunsaturated, cyclic or acyclic or polycyclic hydrocarbyl radical. R⁵ is preferably a C₁-C₄₀ alkyl radical, a C₆-C₄₀ aryl radical, a C₇-C₄₀ alkylaryl radical, a C₇-C₄₀ arylalkyl radical or C₂-C₄₀ (alkoxy)alkyl radical. R⁵ is most preferably a C₁-C₂₀ alkyl radical, a C₆-C₂₀ aryl radical, a C₇-C₂₀ alkylaryl radical, a C₇-C₂₀ arylalkyl radical or C₂-C₂₀ (alkoxy)alkyl radical. R⁵ is especially preferably a C₁-C₁₂ alkyl radical, a C₆-C₁₂ aryl radical, a C₇-C₁₂ alkylaryl radical, a C₇-C₁₂ arylalkyl radical or C₂-C₁₂ (alkoxy)alkyl radical. R⁵ contains preferably zero to four heteroatoms, more preferably zero or one heteroatom, and most preferably no heteroatom. R⁵ is preferably unsubstituted or substituted by one alkoxy group, especially unsubstituted. More preferably, R⁵ consists exclusively of carbon and hydrogen atoms or of carbon and hydrogen atoms and one oxygen atom, in which case this oxygen atom is part of an ether group, i.e. is bonded to two carbon atoms. Examples of R⁵ are methyl, ethyl, 2-methoxyethyl, 1-methyl-2-methoxyethyl, n-propyl, isopropyl, n-butyl, isobutyl, sec-butyl, tert-butyl, n-pentyl, tert-pentyl, n-hexyl, 2-ethyl-hexyl, n-octyl, n-decyl, n-dodecyl, n-tetradecyl, n-hexadecyl, n-octadecyl, n-eicosyl, phenyl or benzyl.

R⁶ and R⁷ may each independently assume the definition of R⁵.

R⁸ is, for example, hydrogen or a linear or branched, saturated or mono- or polyunsaturated, cyclic or acyclic or polycyclic hydrocarbyl radical. R⁸ is preferably hydrogen or a C₁-C₄₀ alkyl radical, a C₆-C₄₀ aryl radical, a C₇-C₄₀ alkylaryl radical or a C₇-C₄₀ arylalkyl radical. R⁸ is more preferably hydrogen or a C₁-C₂₀ alkyl radical, a C₆-C₂₀ aryl radical, a C₇-C₂₀ alkylaryl radical or a C₇-C₂₀ arylalkyl radical. R⁸ is most preferably hydrogen or a C₁-C₁₂ alkyl radical, a C₆-C₁₂ aryl radical, a C₇-C₁₂ alkylaryl radical or a C₇-C₁₂ arylalkyl radical.

Individual hydrogens in R⁸ may preferably be replaced by halogen, preferably fluorine, chlorine or bromine, nitro, hydroxyl, sulfo groups and/or further carboxylic acid groups. Preference is given to 0 to 13 fluorine, chlorine or bromine atoms, 0 to 5 nitro groups, 0 to 5 hydroxyl groups, 0 to 5 sulfo groups and 0 to 10 carboxylic acid groups, particular preference being given to 0 to 9 fluorine, chlorine or bromine atoms, 0 to 3 nitro groups, 0 to 3 hydroxyl groups and 0 to 5 carboxylic acid groups.

Examples of R⁸—COOH are acetic acid, chloroacetic acid, trifluoroacetic acid, trichloroacetic acid, oxalic acid, citric acid, malonic acid, benzoic acid, 3-nitro-benzoic acid, phthalic acid, naphthalenecarboxylic acid, 4-hydroxybenzoic acid.

R⁹ is, for example, a linear or branched, saturated or mono- or polyunsaturated, cyclic or acyclic or polycyclic hydrocarbyl radical. R⁹ is preferably a C₁-C₄₀ alkyl radical, a C₆-C₄₀ aryl radical, a C₇-C₄₀ alkylaryl radical or a C₇-C₄₀ arylalkyl radical. R⁹ is more preferably a C₁-C₂₀ alkyl radical, a C₆-C₂₀ aryl radical, a C₇-C₂₀ alkylaryl radical or a C₇-C₂₀ arylalkyl radical. R⁹ is most preferably a C₁-C₁₂ alkyl radical, a C₆-C₁₂ aryl radical, a C₇-C₁₂ alkylaryl radical or a C₇-C₁₂ arylalkyl radical.

Individual hydrogens in R⁹ may preferably be replaced by halogen, preferably fluorine, chlorine or bromine, nitro, hydroxyl, carboxyl groups and/or further sulfo groups. Preference is given to 0 to 13 fluorine or chlorine atoms, 0 to 5 nitro groups, 0 to 5 hydroxyl groups, 0 to 5 carboxyl groups and 0 to 10 sulfo groups, and with particular preference to 0 to 9 fluorine or chlorine atoms, 0 to 3 nitro groups, 0 to 3 hydroxyl groups and 0 to 5 sulfo groups. Examples of R⁹—SO₂H are methanesulfonic acid, ethanesulfonic acid, propanesulfonic acid, benzenesulfonic acid, toluenesulfonic acid, 2-naphthalenesulfonic acid, trifluoromethanesulfonic acid, naphthalene-1,5-disulfonic acid.

R¹⁰ is, for example, a linear or branched, saturated or mono- or polyunsaturated, cyclic or acyclic or polycyclic hydrocarbyl radical. R¹⁰ is preferably a C₁-C₄₀ alkyl radical, a C₆-C₄₀ aryl radical, a C₇-C₄₀ alkylaryl radical or a C₂-C₄₀ arylalkyl radical. R¹⁰ is more preferably a C₁-C₂₀ alkyl radical, a C₆-C₂₀ aryl radical, a C₇-C₂₀ alkylaryl radical or a C₇-C₂₀ arylalkyl radical. R¹⁰ is most preferably a C₁-C₁₂ alkyl radical, a C₆-C₁₂ aryl radical, a C₇-C₁₂ alkylaryl radical or a C₇-C₁₂ arylalkyl radical. R¹⁰ preferably contains zero to four heteroatoms, most preferably no heteroatom. R¹⁰ is preferably unsubstituted. R¹⁰ most preferably consists exclusively of carbon and hydrogen atoms or is a hydrogen atom. Examples of R¹⁰ are hydrogen, methyl, ethyl, n-propyl, isopropyl, n-butyl, isobutyl, sec-butyl, tert-butyl, n-pentyl, tert-pentyl, n-hexyl, n-heptyl, 1-ethylpentyl, n-octyl, n-nonyl, n-decyl, n-undecyl, n-tridecyl, n-pentadecyl, n-heptadecyl, n-nonadecyl, phenyl, benzyl, 2-methylphenyl, 3-methylphenyl, and 4-methylphenyl.

R¹¹ and R¹² are each independently, for example, hydrogen or linear or branched, saturated or mono- or polyunsaturated, cyclic or acyclic or polycyclic hydrocarbyl radicals. R¹¹ and R¹² are preferably hydrogens, C₁-C₄₀ alkyl radicals, C₆-C₄₀ aryl radicals, C₇-C₄₀ alkylaryl radicals, C₇-C₄₀ arylalkyl radicals or C₂-C₄₀ (alkoxy)alkyl radicals. R¹¹ and R¹² are more preferably hydrogens or C₁-C₂₀ alkyl radicals, C₆-C₂₀ aryl radicals, C₇-C₂₀ alkylaryl radicals, C₇-C₂₀ arylalkyl radicals or C₂-C₂₀ (alkoxy)alkyl radicals. R¹¹ and R¹² are most preferably hydrogen, C₁-C₁₂ alkyl radicals, C₆-C₁₂ aryl radicals, C₇-C₁₂ alkylaryl radicals, C₇-C₁₂ arylalkyl radicals or C₂-C₁₂ (alkoxy)alkyl radicals. R¹¹ and R¹² each preferably contain zero to four heteroatoms, more preferably zero or one heteroatom, and most preferably no heteroatom. R¹¹ and R¹² are preferably unsubstituted or substituted by one alkoxy group, especially unsubstituted. R¹¹ and R¹² most preferably each consist exclusively of carbon and hydrogen atoms. Examples of R¹¹ and R¹² are methyl, ethyl or phenyl.

Most preferred are sulfonic acids, organic resins with sulfo groups, acidic alumina, clay minerals, montmorillonites, acidic zeolites, and iso- and heteropolyacids.

Especially preferred are also organic resins with sulfo groups and acidic montmorillonites.

Examples of organic resins with sulfo groups are gel-type or macroreticular resins which differ especially in terms of pore size, surface area, density and particle size, for example the commercially available acidic ion exchange resins with the trade names Amberlyst® or Amberlite® (from Rohm and Haas/Dow), Lewatit® (from Lanxess) and Dowex® (from Dow Chemical).

Hydrous resins are preferably dried, for example under reduced pressure, or by washing with an alcohol, preferably of the general formula R¹³—OH, or with a volatile inert water-miscible solvent, for example THF, with subsequent removal of the inert solvent under reduced pressure.

Examples of montmorillonites are the commercially available products K10, K20 and KP 10.

Catalysts in heterogeneous form can be used, for example, in the form of powders, granules or shaped bodies, for example rings or rods. They may likewise comprise an inert support. Supports are, for example, crosslinked polymers or silica gel or alumina.

The acidic catalyst is preferably used in proportions by weight of at least 0.01%, more preferably at least 0.1%, and especially at least 0.5%, and at most 100%, more preferably at most 50%, and especially at most 10%, based on the mass of the compound of the general formula II used.

The catalyst can be used in combination with cocatalysts, promoters, moderators or catalyst poisons. Promoters can enhance the action of catalysts. Catalyst poisons can attenuate the action of catalysts or suppress unwanted catalytic effects.

The catalysts can be used directly in the reaction vessel. Heterogeneous catalysts can additionally be used in a parallel catalyst section through which the reaction solution is constantly circulated, for example by pumping, convection or circulation. The catalyst is removed here, for example, by stopping the pumping, convection or circulation operation.

The reaction is performed in the presence of one or more alcohols A. The alcohols A preferably have the formula R¹³—OH, where R¹³ may assume the same definitions and preferred definitions as R³ and may additionally bear OH substituents. In the aforementioned formulae, the OR³ and OR⁴ groups may be partly or fully replaced by OR¹³ groups, in which case alcohols of the structure R³—OH or R⁴—OH can be formed, and the R¹—C(═O)— groups in the aforementioned formulae may be replaced by hydrogen. When R¹³ has a plurality of alcoholic OH functions, several exchange reactions of this kind can take place, such that corresponding structures bridged via R¹³ are formed.

In contrast to the process described in Chemische Berichte 1966, volume 99, p. 1368-1383, in which 13 molar equivalents of alcohol are present in the reaction mixture, the presence of a significantly smaller amount of alcohol of not more than 7 molar equivalents in the process according to the invention achieves significantly higher space-time yields.

Preferably at least 0.05, more preferably at least 0.1 and at most 4 and more preferably at most 2 molar equivalents of alcoholic OH groups of the alcohol A are present per 1 molar equivalent of [O—CH₂—Si(R²)₂] units of the compounds of the general formula II in the reaction mixture.

The amounts may be lower than the upper limits specified by virtue of supply of alcohol A, especially of the formula R¹³—OH, and removal of a corresponding amount of the reaction product of the general formula III, alcohol of the formula R¹³—OH and/or R³—OH and/or R⁴—OH, which may be present as mixtures, from the mixture (for example distillation, possibly together with other compounds present in the mixture), such that the molar equivalent limits specified for the alcohols in the mixture are not exceeded, or by virtue of supply, over the course of the process, of a total of preferably more than 0.1 but less than 4 molar equivalents of alcohol A in total, based on 1 molar equivalent of [O—CH₂—Si(R²)₂] units of the compounds of the general formula II.

The reaction through which the compounds of the general formula II react to give compounds of the general formula I can be executed, for example, in the gas phase, in the liquid phase, in the solid phase, in the supercritical state, in supercritical media, in solution or in substance, i.e. neat. Preference is given to executing the process in the liquid phase, in solution or in substance, preferably in the liquid phase, preferably in substance, more preferably in the liquid phase and in substance.

The process can be performed over a wide temperature range, for example at least 0° C., preferably at least 30° C., more preferably at least 40° C., and most preferably at least 50° C., and, for example, at most 400° C., preferably at most 300° C., more preferably at most 250° C., and most preferably at most 200° C.

The process can be executed over a wide pressure range, for example at least 0.1 Pa, preferably at least 1 Pa, more preferably at least 10 Pa, and most preferably at least 100 Pa and, for example, at most 500 MPa, preferably at most 10 MPa, more preferably at most 1 MPa, and most preferably at most 500 kPa absolute. In a particularly preferred embodiment, the process is executed at atmospheric pressure, which, according to the ambient conditions, is generally within a range between 90 and 105 kPa absolute.

The process can be executed continuously or batchwise. In the batchwise embodiment, the process can be executed, for example, in a cascade reactor or in a stirred tank. In the continuous embodiment, the process can be executed, for example, in a tubular, delay, circulation or cascade reactor, or a dynamic or static mixer.

If compounds of the general formula II in which n has a particular value or particular values are used as the reactant in the process, in the course of execution of the process, compounds of the general formula IIa may occur

R¹—C(═O)—[O—CH₂—Si(R²)₂]ₘ—OR³ (IIa)

where R¹, R² and R³ may assume the definitions given above and m may assume integer values greater than or equal to 1, and in which m has values which differ from the values for n as possessed by the compounds of the formula II used.

If, in the process, for example, the particularly preferred compounds of the general formula II in which n has the value of 1 are used as the reactant, in the course of execution of the process, compounds of the general formula IIa in which m has values greater than or equal to 2 may occur.

m may assume, for example, values of 2 to 100, for example 2, 3, 4, 5, 6, 7, 8, 9 or 10.

The structural unit [O—CH₂—Si(R²)₂]ₘ in the general formula IIa may be linear or, if at least one of the R² radicals has been selected from radicals of the structure OR⁴, branched, in which case R⁴ may assume the definitions given above and in which case reaction with the alcohols R¹³—OH may result in exchange of OR⁴ for OR¹³. If, for example, the compound of the general formula II chosen was (acetoxymethyl)trimethoxysilane (i.e. the choices were: R¹=Me, R²=OMe, OR³=OMe, n=1), in the course of the reaction, for example, compounds including the following compounds of the formula IIa may occur:

Me-C(═O)—[O—CH₂—Si(OMe)₂-O—CH₂—Si(OMe)₂]—OMe m=2 (linear)

Me-C(═O)—[O—CH₂—Si(OMe)₂-O—CH₂—Si(OMe)₂-O—CH₂—Si(OMe)₂]—OMe m=3 (linear)

Me-C(═O)—[O—CH₂—Si(O—CH₂—Si(OMe)₃)₂]—OMe m=3 (branched)

Me-C(═O)—[O—CH₂—Si(O—CH₂—Si(OMe)₃)₂—O—CH₂—Si(OMe)₂]—OMe, m=4 (branched, selected example)

where the structural units in square brackets always have the empirical formula of [O—CH₂—Si(OMe)₂]ₘ with the particular value specified for m.

In the compounds of the general formula IIa, in the presence of alcohol R¹³—OH, the R¹CO radicals may be replaced by hydrogen; these compounds are represented by the formula IIb:

H—[O—CH₂—Si(R²)₂]ₘ—OR³ (IIb)

In the aforementioned formulae, in the presence of one or more alcohols R¹³—OH, the OR³ groups and possibly the OR⁴ groups may be partly or fully replaced by OR¹³ groups, in which case alcohols of the structure R³—OH and possibly R⁴—OH may be formed.

The compounds of the general formulae IIa and IIb may, in the process according to the invention, be converted further to compounds of the general formula I. This can possibly form compounds of the general formula III and/or alcohols R¹³—OH, R³—OH and possibly R⁴—OH as by-products.

In the presence of alcohol of the general formula R¹³—OH, the compounds of the general formula IIb are in an equilibrium dependent on the amount of alcohol with the compounds of the general formula I. Removal of the alcohol, which can be effected, for example, by distillation, results in a shift in the equilibrium in favor of the compounds of the general formula I.

The process can be executed, for example, under reflux or under distillative conditions, optionally under partial reflux, for example in a distillation apparatus, a thin-film or falling-film evaporator, optionally in a column with separating performance. For example, one or more compounds of the general formulae I, II or III and optionally the alcohols R¹³—OH and R³—OH and any R⁴—OH can be distilled out of the mixture.

In a first preferred embodiment, the compound of the general formula III (in which the OR³ groups may be partly or fully replaced by OR¹³ groups) is distilled out and the compounds of the general formulae I, IIa, IIb and II and the alcohols R¹³—OH and R³—OH and any R⁴—OH are at first kept partly or completely in the reaction mixture, for example via return or reflux, and, once the compound of the general formula III has been partly or fully distilled off, the alcohols R¹³—OH and R³—OH and any R⁴—OH are optionally distilled off.

The removal of the acidic catalyst preferably follows substantially complete formation of the compound of the general formula III or, equally preferably, follows removal of the compound of the general formula III from the reaction mixture, or, equally preferably, follows removal of the compound of the general formula III and optionally of the alcohols R¹³—OH and R³—OH and any R⁴—OH from the reaction mixture.

The acidic catalyst can be removed, for example, by chemical elimination of the acid function, such as neutralization with a base, or else physically, for example by filtration, decantation, centrifugation, or by physical interruption of the contact of the reaction mixture with the acidic catalyst.

In the case of use of heterogeneous acidic catalysts, the removal is preferably effected physically, by removal by filtration, removal by decantation, removal by centrifugation, or by physical interruption of the contact of the reaction mixture with the acidic catalyst, and in the case of use of an external catalyst section, most preferably by interruption of the contact between acidic catalyst and the predominant portion of the reaction solution, for instance by interrupting the circulation of the reaction mixture through the catalyst section. The physical removal enables, in a simple manner, the repeated use of the acidic catalyst.

If the removal is effected by neutralization, preferably at least 0.5, more preferably at least 0.9 and especially at least 1 molar equivalent, and preferably at most 3, more preferably at most 1.5 and especially at most 1.2 molar equivalents of a base are used, based on 1 mol of the catalytically active acid groups used in the acidic catalyst.

The base used is preferably metal hydrogencarbonate, metal carbonate, metal hydroxide or metal oxide, preferably metal hydrogencarbonate or metal carbonate, and most preferably metal hydrogencarbonate, with a metal selected from Li, Na, K, Rb, Cs, Mg, Ca, Sr, Ba, Al, Fe, Co, Ni or Zn, preferably Li, Na, K, Mg, Ba, Fe or Zn, most preferably Na, K, Mg, Ca or Fe, ammonia, alkylammonium hydroxide, amine base, or guanidine base, amidine base or basic ion exchange resins. Examples of neutralizing bases are sodium hydrogencarbonate, sodium carbonate, barium carbonate, potassium hydrogencarbonate, potassium carbonate, calcium carbonate, calcium hydroxide, lithium hydroxide, magnesium oxide, ammonia, triethylamine, ethylenediamine, cyclohexylamine, pyridine, piperidine, DBN, DBU, DABCO, guanidine or tetramethylguanidine, and basic ion exchangers.

The product of the general formula I can subsequently be distilled over, in which case the compounds of the general formulae II, IIa and IIb are kept partly or fully in the reaction mixture, for example via return or reflux.

In a further preferred embodiment, the product of the general formula I, after distillative removal of the compounds of the general formula III and optionally of the alcohols R¹³—OH and R³—OH and/or R⁴—OH and after removal of the acidic catalyst, is left in a mixture with the compounds of the general formulae IIa, IIb and II.

Preferably, unconverted compounds of the general formula II and any compounds of the general formulae IIa and IIb obtained are used in a new batch which is preferably executed after the process according to the invention. The compounds of the general formulae IIa or IIb which may originate from other sources can likewise be used in the process according to the invention.

In the process, it is optionally possible to add esters of the structure R¹⁴—C(═O)—OR¹³ where R¹³ may assume the same definitions as defined above and R¹⁴ may assume the same definitions as defined above for R¹. In this case, in the aforementioned formulae, the OR³ and any OR⁴ groups may be partly or fully replaced by OR¹³ groups and the R¹—C(═O)— groups may be partly or fully replaced by R¹⁴—C(═O)— groups.

In the process, it is optionally possible to use or add solvents or mixtures of solvents. Examples of usable solvents are optionally halogenated, for example chlorinated, or halogen-free hydrocarbons, ketones, ethers and esters. If esters are used as solvents, further transesterification reactions may occur, which, if these effects are unwanted, can lead to a restriction in the selection of esters. The solvents may be saturated or unsaturated; unsaturated solvents preferably have aromatic unsaturation. Examples of usable solvents are isomers of C₅-C₄₀ hydrocarbons, for example cyclohexane, heptane, octane, isooctane, nonane, decane, dodecane, benzene, toluene, ortho-, meta- or para-xylene or -cymene, cumene, ethylbenzene, diethylbenzene, or hydrocarbon mixtures, for example those from the Shellsol series from Shell or from the Hydroseal series from Total, C₃-C₄₀ ketones such as acetone, butanone, 2-pentanone, 3-pentanone, 3-methylbutanone, 4-methylpentan-2-one, cyclohexanone, ethers such as tetrahydrofuran, diethyl ether, tert-butyl methyl ether, tert-amyl methyl ether, diisopropyl ether, halogenated hydrocarbons such as chlorobenzene, ortho-, meta- or para-dichlorobenzene, or the isomers of trichlorobenzene.

Preference is given to using a minimum amount of solvent in the process: the mass of solvent, the total of all solvents, is preferably less than five times the mass of compounds of the general formula II used in total, more preferably less than twice the amount, most preferably less than half the amount. In a particularly preferred embodiment, the process is executed without added solvents.

The process is preferably executed under inert conditions. Solvents and reactants used contain preferably less than 10,000 ppm of water, more preferably less than 1000 ppm, and most preferably less than 200 ppm. Gases used, for example protective gas, contain preferably less than 10,000 ppm of water, more preferably less than 1000 ppm, and most preferably less than 200 ppm, and preferably less than 10,000 ppm of oxygen, more preferably less than 1000 ppm, and most preferably less than 200 ppm. Catalysts used contain preferably less than 50% water, more preferably less than 20%, and most preferably less than 5%.

Compounds of the general formula I prepared by the process according to the invention can, for example, be used directly as obtained, i.e. possibly in a mixture with compounds of the general formulae II, IIa, IIb, III and further additives present in the reaction mixture, for subsequent chemical reactions or other applications.

Preference is given to enriching the compounds of the general formula I in the reaction mixture. This is preferably accomplished by removing the compounds of the general formula III and the alcohols R¹³—OH and R³—OH from the reaction mixture, preferably by distillation.

If the conversion to form compounds of the general formula III is complete, the residue comprises, after removal of compounds of the general formula III and the alcohols R¹³—OH and R³—OH, as well as the product of the general formula I, especially also compounds of the general formula IIb (see also examples 3, 6, 8 and 9 below) which, like the compounds of the general formula I, are suitable for terminating reagents for polysiloxanes analogously to equation 1; cf. examples 11 and 12 of the application DE 10-2009-046254.

Optionally, however, a distillation of the compounds of the general formula I may follow; in the bottoms, the compounds of the general formulae IIa and IIb are converted further here to I.

Optionally, redistillation can be effected.

Prepared compound of the general formula I may be obtained, for example, in liquid form or may solidify or crystallize.

All above symbols in the above formulae are each defined independently of one another.

In the examples which follow, unless stated otherwise in each case, all amounts and percentages are based on the weight, all pressures are 0.10 MPa (abs.) and all temperatures are 20° C.

### EXAMPLES

### Example 1

### Catalyst: p-toluenesulfonic Acid

20.0 g (135 mmol) of formoxymethyldimethylmethoxysilane (formula II where R¹═H, R²═R³═CH₃, n=1) were admixed with 8 ml (corresponding to 6.3 g, 197 mmol) of methanol and 200 mg of p-toluenesulfonic acid, and the mixture was heated to 63° C. The methyl formate formed was distilled off using a distillation apparatus in a mixture with methanol and the volume distilled off was replaced in the bottoms by methanol. A total of 8.5 ml (corresponding to 6.72 g, 210 mmol) of methanol were added. Toward the end of the reaction, the bottom temperature rose to 71° C. and the top temperature to 64° C. (boiling point of methanol).

500 mg of sodium hydrogencarbonate were added for removal of acid and the mixture was fractionally distilled under reduced pressure. This gave approx. 8 g (68%) of 2,2,5,5-tetramethyl-2,5-disila-1,4-dioxacyclohexane (formula I, x=1) with boiling point 57° C./20 mbar.

### Example 2

### Catalyst: p-toluenesulfonic Acid

20.0 g (135 mmol) of acetoxymethyldimethylethoxysilane (formula II where R¹═CH₃, R²═CH₃, R³═CH₂CH₃, n=1) were admixed with 8 ml (corresponding to 6.3 g, 197 mmol) of methanol and 200 mg of p-toluenesulfonic acid, and the mixture was heated to 75° C. The methyl acetate formed was distilled off using a distillation apparatus in a mixture with methanol and the volume distilled off was replaced in the bottoms by methanol. A total of 33 ml (corresponding to 26 g, 816 mmol) of methanol were added. The top temperature rose to 64° C. The reaction mixture contained, during the conversion, a maximum of 2 equivalents of methanol (NMR analysis).

510 mg of sodium hydrogencarbonate were added for removal of acid and the mixture was fractionally distilled under reduced pressure. This gave approx. 8 g (80%) of 2,2,5,5-tetramethyl-2,5-disila-1,4-dioxacyclohexane (formula I, x=1) with boiling point 57° C./20 mbar.

### Example 3

### Catalyst: Amberlyst® 46 w, Catalyst Section

200 g (1.35 mol) of formoxymethyldimethylmethoxysilane (formula II where R¹═H, R²═R³═CH₃, n=1) were admixed with 31 g (0.97 mol) of methanol and heated to 80° C. The mixture was pumped continuously through a column which was filled with the acidic ion exchange resin Amberlyst® 46 w containing sulfo groups and was purged with methanol for removal of water (total volume 70 ml, Amberlyst® 46 bed volume: 35 ml) at a pumping rate of 124 ml/min back into the reaction vessel. At the same time, methyl formate formed (formula III, R¹═H, R²═CH₃) was distilled off in a mixture with methanol through a short column with random packing and the distillate in the reaction vessel was replaced by the same volume of methanol. During the distillation, the proportion of methanol in the distillate rose to above 90%. A total of 158 g, corresponding to 4.39 mol, of methanol were used. After a reaction time of about 3.5 h, the pumping was ended and residual methanol was removed from the bottoms by distillation at standard pressure. This gave 93 g of residue of the composition 55% 2,2,5,5-tetramethyl-2,5-disila-1,4-dioxacyclohexane (formula I, x=1) and about 45% of the compounds according to formula IIb where R²═R³═CH₃.

### Kinetic Analysis:

During the reaction, the percentage content of formate groups was determined as a measure for the degree of conversion (NMR analysis in d₆-benzene, measurement points after 60, 90, 120, 150, 180 and 210 min). After 210 min, the proportion of formate groups was 0.2%, i.e. 99.8% conversion had been attained; see table 1.

TABLE 1
Proportion of formate groups in examples 3 and
4 as a function of reaction time

| Reaction time | Formate groups | Formate groups |
|---|---|---|
| (min) | (%), ex. 3 | (%), ex. 4 |
| 60 | 9.5 | 10.9 |
| 90 | 4.5 | 4.8 |
| 120 | 2.2 | 2.4 |
| 150 | 1.0 | 1.1 |
| 180 | 0.5 | 0.6 |
| 210 | 0.2 | 0.2 |

### Example 4

### Reuse of the Catalyst from Example 3, Catalyst Section

The experiment according to example 2 was repeated with the catalyst from example 2 and the kinetic analyses were conducted analogously Within the range of measurement accuracy, the reaction proceeded with approximately the same reaction rate as in example 3 (table 1). No deactivation of the catalyst takes place.

After distillative removal of methanol, this gave 96.5 g of residue. 87.7 g thereof were fractionally distilled at 21 mbar. At the top temperature of 54-57° C., 76 g (87% based on crude product used) of 2,2,5,5-tetramethyl-2,5-disila-1,4-dioxacyclohexane (formula I where x=1) of purity 99.5% were obtained in a mixture with about 0.4% 2,2,5,5,8,8-hexamethyl-2,5,8-trisila-1,4,7-trioxacyclononane (formula I where x=2).

### Example 5

### Catalyst: Amberlyst® 46 w, Catalyst Section

304 g (2.05 mol) of formoxymethyldimethylmethoxysilane (formula II where R¹═H, R²═R³═CH₃, n=1) were, as in example 3, converted with addition of 217 g (6.80 mol) of methanol using 27.8 g of Amberlyst® 46 w catalyst dried under reduced pressure. The reaction time was 4 h. After complete removal of methanol, the residue (173 g) was fractionally distilled under reduced pressure. This gave 158 g (87%) of 2,2,5,5-tetramethyl-2,5-disila-1,4-dioxacyclohexane (formula I where x=1) with boiling point 56° C./22 mbar.

### Example 6

### Catalyst: Amberlyst® 39 w, Reuse of the Catalyst

The reaction according to example 3 was conducted three times in succession with the same Amberlyst® 39 w catalyst. After removal of methanol, a mixture comprising 63% 2,2,5,5-tetramethyl-2,5-disila-1,4-dioxacyclohexane (formula I where x=1) and 37% compounds of the formula IIb where R²═R³═CH₃ was obtained.

### Kinetic Analysis:

During the 2^{nd} and 3^{rd} reaction, the percentage content of formate groups was determined as a measure for the degree of conversion (NMR analysis in d₆-benzene, measurement points after 60, 90, 120 and 150 min). No significant differences are found in the curve series, i.e. no catalyst deactivation. After 150 min, the proportion of formate groups was approx. 0.7%, i.e. 99.3% conversion was attained; see table 2.

TABLE 2
Proportion of formate groups in example 6, 2^{nd}
and 3^{rd} reaction as a function of reaction time

| Reaction time | Formate groups | Formate groups |
|---|---|---|
| (min) | (%), 2^{nd} reaction | (%), 3^{rd} reaction |
| 60 | 12.0 | 10.0 |
| 90 | 5.1 | 5.2 |
| 120 | 2.4 | 1.9 |
| 150 | 0.8 | 0.6 |

### Example 7

### Catalyst: Amberlyst® 15 w, Catalyst Section, Reuse of the Catalyst

The reaction according to example 3 was conducted twice using the same Amberlyst® 15 w catalyst.

The kinetic profile of the reaction was in each case determined as in example 3. In both reactions, the conversion after 90 min was 92% and was complete after 4 h, i.e. no catalyst deactivation.

### Example 8

### Amberlyst® 39 w Catalyst

For removal of water, 25 g of Amberlyst® 39 w were washed twice with methanol and the methanol was decanted off. 506 g (3.41 mol) of formoxymethyl-dimethylmethoxysilane (formula II where R¹═H, R²═R³═CH₃, n=1) were heated to 58 to 78° C. together with the washed Amberlyst® and 198 g (6.18 mol) of methanol, in the course of which the methyl formate formed was distilled off in a mixture with methanol. After complete removal of the methyl formate, the catalyst was filtered off and the methanol was removed on a rotary evaporator. This gave 307 g of residue of the composition 38% 2,2,5,5-tetramethyl-2,5-disila-1,4-dioxacyclohexane (formula I where x=1) and 62% formula IIb where R²═R³═CH₃ (NMR analysis).

### Example 9

### Amberlyst® 39 w Catalyst

35.6 g (0.236 mol) of formoxymethyldimethylmethoxy-silane (formula II where R¹═H, R²═R³═CH₃, n=1) with addition of 5.5 g (0.17 mol) of methanol and 1.78 g (5% by weight) of Amberlyst® 39 w, which had been washed 2× with methanol and dried at 10 mbar beforehand for removal of water, were heated to 70 to 74° C. and the methyl formate formed was distilled off in a mixture with approx. 10% methanol using a column with random packing (length approx. 15 cm, glass spirals). Methanol was removed by distillation at bottom temperature up to 100° C. The ion exchanger was filtered off and traces of methanol were removed distillatively at 1 mbar. The resulting residue consisted of about 42% 2,2,5,5-tetramethyl-2,5-disila-1,4-dioxacyclohexane (formula I, x=1) and 58% of the compounds according to formula IIb where R²═R³═CH₃.

### Example 10

### Catalyst Screening

Catalyst preparation: the hydrous catalysts Amberlyst® 15 wet, 16 wet, 35 wet, 36 wet and 39 wet, for removal of water, were washed repeatedly with methanol and dried under reduced pressure (10 mbar). All other catalysts were used without pretreatment.

General experimental method: 10.0 g of formoxymethyl-dimethylmethoxysilane (formula II where R¹═H, R²═R³═CH₃, n=1) of purity 99.1% (66.9 mmol) were admixed with 0.50 g of catalyst and 2.0 g (62.5 mmol) of methanol, and heated to 70° C. over a total period of 1 h. Methyl formate formed was distilled off by means of a microdistillation apparatus.

Tab. 3 shows the percentage conversions obtained after 15 min and 60 min (=100−percentage of formate groups in the reaction mixture) and the amount of distillate obtained in each case, which comprised methyl formate and methanol.

TABLE 3
Catalyst screening results

| | | | | Distillate | |
|---|---|---|---|---|---|
| | | | | composition | |
| | Conversion (%) | | | | Methyl |
| | after | | | MeOH | formate |
| | 15 min | 60 min | Distillate g | mol % | mol % |
| Catalyst: | | | | | |
| Amberlyst ® | | | | | |
| 15wet | 60.5 | 76.5 | 3.52 | 41 | 59 |
| 15dry | 67.0 | 78.7 | 3.47 | 38 | 62 |
| 16wet | 58.4 | 75.5 | 3.40 | 42 | 58 |
| 35wet | 63.3 | 79.1 | 3.48 | 40 | 60 |
| 35dry | 63.0 | 78.1 | 3.41 | 41 | 59 |
| 36wet | 60.0 | 76.6 | 3.29 | 37 | 63 |
| 36dry | 66.4 | 79.5 | 3.47 | 39 | 61 |
| 39wet | 64.8 | 77.9 | 3.67 | 45 | 55 |
| 46 | 57.9 | 78.4 | 3.28 | 37 | 63 |
| 70 | 59.8 | 78.3 | 3.34 | 38 | 62 |
| Catalyst: | | | | | |
| montmorillonite | | | | | |
| K10 (pH 2.5-3.5) | 34.5 | 59.6 | 2.24 | 40 | 60 |
| K20 (pH 3-4) | 41.3 | 74.0 | 2.99 | 34 | 66 |
| KP10 (pH 1.5-2.5) | 17.6 | 38.0 | 1.07 | 43 | 57 |

### Example 11

Analogously to example 9, 100.1 g (675 mmol) of formoxymethyldimethylmethoxysilane (formula II where R¹═H, R²═R³═CH₃, n=1), with addition of 20 ml of methanol and 5.0 g (5% by weight) of K20 montmorillonite, were heated to 72 to 78° C. and the methyl formate formed was distilled off using a column with random packing (length approx. 15 cm, glass spirals) in a mixture with about 10% methanol, in the course of which a further 40 ml of methanol were metered in. Therefore, a total of 60 ml of methanol (47.5 g, 1.48 mol) were used. Methanol was removed by distillation at bottom temperature up to 103° C. The heterogeneous catalyst was filtered off and the reaction mixture was fractionally distilled. This gave g (60%) of 2,2,5,5-tetramethyl-2,5-disila-1,4-dioxacyclohexane (formula I, x=1).

### Example 12

### Catalyst: Amberlyst 46, Catalyst Section

440 g of acetoxymethyldimethylmethoxysilane (purity 99.2%, 2.69 mol) (formula II where R¹═R²═R³═CH₃, n=1) were admixed with 63 g (1.98 mol) of methanol and heated to 80° C. The mixture was pumped continuously through a column filled with Amberlyst 46® and purged with methanol (total volume 90 ml, Amberlyst® 46 bed volume: 43 ml) at a pumping rate of 130 ml/min back into the reaction vessel. At the same time, methyl acetate formed (formula III, R¹═R²═CH₃) was distilled off in a mixture with methanol using a short column with random packing and the distillate was replaced in the reaction vessel by the same volume of methanol. In the distillates, the proportions of methanol rose from approx. 55 mol % up to 92 mol % based on methyl acetate. The molar proportion of methanol in the reaction mixture during the conversion was about 1 equivalent based on the amount of Si units. A total of 530 g (16.6 mol) of methanol were used. After a reaction time of about 8 h, the pumping was ended and residual methanol was removed from the bottoms by distillation at standard pressure. The bottoms (amount 183 g—losses caused by dead volume of the apparatus) were fractionally distilled under a reduced pressure of 14 mbar. This gave 140.5 g of 2,2,5,5-tetramethyl-2,5-disila-1,4-dioxacyclohexane (formula I where x=1, yield 77% based on the bottoms used) with boiling point 52° C. in a mixture with about 0.5% 2,2,5,5,8,8-hexamethyl-2,5,8-trisila-1,4,7-trioxacyclononane (formula I where x=2).

### Example 13

### Comparative Example

A further reaction was conducted under conditions as in example 1 and distilled without neutralization. As well as unidentified products, the distillate (8.6 g) contained not more than 15% 2,2,5,5-tetramethyl-2,5-disila-1,4-dioxacyclohexane (formula I, x=1).

1.-10. (canceled)

11. A process for preparing silaoxacycles of the formula I 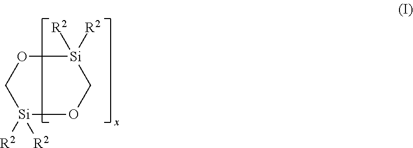
in which compounds of the general formula II
R¹—C(═O)[O—CH₂—Si(R²)₂]ₙ—OR³ (II)
are reacted in the presence of one or more acidic catalysts selected from the group consisting of organic resins with sulfo groups, acidic alumina, clay minerals, montmorillonites, acidic zeolites, iso- and heteropolyacids, and at least one alcohol A, using 0.01 to 7 molar equivalents of alcoholic OH groups of the alcohol A per 1 molar equivalent of [O—CH₂—Si(R²)₂] units of compounds of the formula II, and isolating silaoxacycles of the formula I after removing the acidic catalyst,
where
x is an integer ≧0,
n is an integer ≧1,
R¹ is a hydrocarbyl radical which is unsubstituted or substituted by one or more Q¹ groups and is optionally interrupted by one or is more heteroatoms, or an OR³ group,
R² is a hydrocarbyl radical which is unsubstituted or substituted by one or more Q¹ groups and is optionally interrupted by one or more heteroatoms, or is an OR⁴ group,
R³ is a hydrocarbyl radical which is unsubstituted or substituted by one or more Q¹ groups and is optionally interrupted by one or more heteroatoms,
R⁴ is a hydrocarbyl radical which is unsubstituted or substituted by one or more Q¹ groups and is optionally interrupted by one or more heteroatoms, and
Q¹ is a monovalent, divalent or trivalent heteroatom-containing radical,
where R¹, R², R³, R⁴ and Q¹ may be joined to one another so as to form one or more rings.

12. The process of claim 11, in which the silaoxacycles of the formula I are isolated by distillation.

13. The process of claim 12, in which the alcohol(s) A have the formula R¹³—OH where R¹³ has the definition of R³ and optionally additionally bear OH substituents.

14. The process of claim 11, in which x is from 1 to 3.

15. The process of claim 11, in which R¹ is a hydrogen atom, a C₁-C₁₂ alkyl radical, a C₆-C₁₂ aryl radical, a C₇-C₁₂ alkylaryl radical or a C₇-C₁₂ arylalkyl radical.

16. The process of claim 11, in which R² is a C₁-C₁₂ alkyl radical, a C₆-C₁₂ aryl radical, a C₇-C₁₂ alkylaryl radical or a C₇-C₁₂ arylalkyl radical, a C₁-C₁₂ alkoxy radical, a C₂-C₁₂ (alkoxy)alkoxy radical, a C₆-C₁₂ aryloxy radical, a C₇-C₁₂ arylalkoxy radical or a C₇-C₁₂ alkylaryloxy radical.

17. The process of claim 11, in which R³ is a C₁-C₁₂ alkyl radical, a C₆-C₁₂ aryl radical, a C₇-C₁₂ alkylaryl radical, a C₇-C₁₂ arylalkyl radical or a C₂-C₁₂ (alkoxy)alkyl radical.

18. The process of claim 11, in which the R¹ radical is a hydrogen i atom, a methyl group or an ethyl group, the R² radicals are each independently methyl, methoxy or ethoxy groups, the R³ radical is a methyl or ethyl group, n is an integer from 1 to 3 and x is an integer from 1 to 3.

19. The process of claim 11, in which the acidic catalyst is a Brønsted acid having a pKₐ value of −12 to +9.
